(19) United States
(12) Patent Application Publication
(10) Pub. No.: US 2004/0133911 A1
(43) Pub. Date: Jul. 8, 2004

(54) Subscriber network in a satellite system

(76) Inventors: Samuel H. Russ, Lawrenceville, GA (US); David B. Lett, Duluth, GA (US); Ajith N. Nair, Lawrenceville, GA (US); Bohdan S. Prus, Alpharetta, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/712,289

(22) Filed: Nov. 13, 2003

Related U.S. Application Data
(63) Continuation-in-part of application No. 10/342,670, filed on Jan. 15, 2003.
(63) Continuation-in-part of application No. 10/403,485, filed on Mar. 31, 2003.
(60) Provisional application No. 60/426,705, filed on Nov. 15, 2002.
(60) Provisional application No. 60/416,155, filed on Oct. 4, 2002.
(60) Provisional application No. 60/416,155, filed on Oct. 4, 2002.

(51) Int. Cl. H04N 7/20

(52) U.S. Cl. 725/69; 725/68

(57) ABSTRACT

Systems and methods are disclosed for providing downstream signals to a plurality of satellite receiving devices. A networked multimedia system receives the satellite signals from the receiving device. The networked multimedia system includes a splitter, a primary home communications terminal (DHCT), and a plurality of remote devices. The remote devices communicate with the primary DHCT via the splitter. Accordingly, the remote devices utilize some or all of the features including hardware and software that are included in the primary DHCT via the networked multimedia system.

### CROSS-REFERENCE TO RELATED PATENT APPLICATIONS

The present application claims priority to U.S. provisional application serial No. 60/426,705 filed on Nov. 15, 2002. Additionally, the present application is a continuation-in-part of U.S. patent application Ser. No. 10/342,670 entitled “Networked Multimedia System” filed Jan. 15, 2003, which claims priority to U.S. provisional application serial No. 60/416,155 filed Oct. 4, 2002; and a continuation-in-part of U.S. patent application Ser. No. 10/403,485 entitled “Networked Multimedia System having a Multi-Room Interactive Guide” filed Mar. 31, 2003, which claims priority to U.S. provisional application serial No. 60/416,155 filed Oct. 4, 2002. Furthermore, the present application incorporates by reference in its entirety herein copending U.S. patent applications having Ser. Nos. 10/263,160; 10/263,449; and 10/263,270, which were filed on Oct. 2, 2002 and are assigned to a common assignee, the disclosures and teachings of which are hereby incorporated by reference.

### FIELD OF THE INVENTION

This invention relates in general to broadband satellite communications systems, and more particularly, to the field and functionality of a networked multimedia system having a plurality of receiving terminals that is suitable for use in the broadband communications system.

### DESCRIPTION OF THE RELATED ART

Broadband communications systems, such as satellite and cable television systems, are now capable of providing many services in addition to analog broadcast video. In implementing enhanced programming, a digital home communications system (DHCT), otherwise known as the set-top box, has become an important computing device for accessing various video services. In addition to supporting traditional analog broadcast video functionality, many DHCTs now also provide other functionality, such as, for example, an interactive program guide (IPG), video-on-demand (VOD), subscription video-on-demand (SVOD) and functionality traditionally associated with a conventional computer, such as e-mail. Recently new functionality has been added to conventional DHCTs—namely the ability to record an incoming video stream in digitized form onto a mass storage device, such as a hard disk drive, and play back that recorded video as desired by the user. This functionality has become known as a digital video recorder (DVR) or personal video recorder (PVR) and is viewed as a superior alternative to conventional video tape recorders for capture and subsequent playback of programming content.

A DHCT is typically connected to a communications network (e.g., a cable or satellite television network) and includes hardware and software necessary to provide various services and functionality. Preferably, some of the software executed by a DHCT is downloaded and/or updated via the communications network. Each DHCT also typically includes a processor, communication components, and memory, and is connected to a television or other display device. While many conventional DHCTs are stand-alone devices that are externally connected to a television, a DHCT and/or its functionality may be integrated into a television or other device, as will be appreciated by those of ordinary skill in the art.

A DHCT is typically connected to a television set and located at the home of the cable or satellite system subscriber. Since the DHCT is located at a subscriber's premises, it typically may be used by two or more users (e.g., household members). Television has become so prevalent in the United States, however, that the typical household may have two or more television sets, each television set requiring its own DHCT player if the subscriber wishes to have access to enhanced functionality. Additionally, each television set requires its own video cassette recorder (VCR) or digital video disc (DVD) player. However, the DHCTs and other peripheral devices can be expensive and users may not be willing to purchase additional devices. This is particularly true of DHCTs incorporating PVR functionality since such devices require not only the addition of a hard disk drive but also additional processing components and software.

Therefore, there exists a need for systems and methods for addressing these and/or other problems associated with DHCTs and peripheral devices. Specifically, there exists a need for systems and methods that allow multiple users operating discrete DHCTs within a networked premises or other local area to operate a central unit such as a VCR, DVD player, or other device having recording and playback functions.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 is a simplified block diagram depicting a non-limiting example of a conventional broadband satellite communications system for one subscriber.

FIG. 2 is a block diagram illustrating a switch that receives signals from a home satellite receiver and provides the signals to a plurality of receiving devices.

FIG. 3 is a block diagram illustrating one preferred embodiment of a networked multimedia system (NMS) that is suitable for use in the satellite communications system of FIG. 1 in accordance with the present invention.

FIG. 4 is an illustration of a switch in accordance with the present invention that is suitable for use in the NMS of FIG. 3.

### DETAILED DESCRIPTION OF THE PREFERRED EMBODIMENTS

Preferred embodiments of the invention can be understood in the context of a broadband satellite communications system and a local network system. Note, however, that the invention may be embodied in many different forms and should not be construed as limited to the embodiments set forth herein. For example, transmitted broadband signals may include at least one of video/audio, telephony, data, and Internet Protocol (IP) signals, to name but a few. Additionally, receiving devices (i.e., a primary device and a plurality of remote devices) included in a local network system receiving the transmitted broadband signals may include a digital home communications terminal (DHCT), a television, a computer, a personal digital assistant (PDA), or other device. All examples given herein, therefore, are intended to be non-limiting and are provided in order to help clarify the description of the invention.

The present invention is directed towards a broadband satellite communications system including a networked multimedia system (NMS). The NMS is typically located within a subscriber premise. It will be appreciated, however, that the NMS can also be used in a multi-unit dwelling, business, school, hotel, or hospital, among others. Advantageously, the NMS allows the premises to be locally networked (i.e., home networked). In accordance with the present invention, a primary DHCT receives and forwards stored multimedia content signals, for example, digital or analog cable television programs, Internet Protocol (IP) signals, VOD signals, software application signals, to name some examples, to a plurality of remote devices in the NMS through the NMS. Additionally, the remote devices are each capable of requesting from the primary DHCT and seamlessly receiving, for example, a stored presentation, just as if the remote devices were equipped with the primary DHCT functionality. In other words, the remote devices may be simplified, less-costly versions of the primary DHCT but are capable of utilizing, via the local network, some or all of the advanced hardware and software features, such as memory, a mass storage device, or software applications, that are available in the primary DHCT.

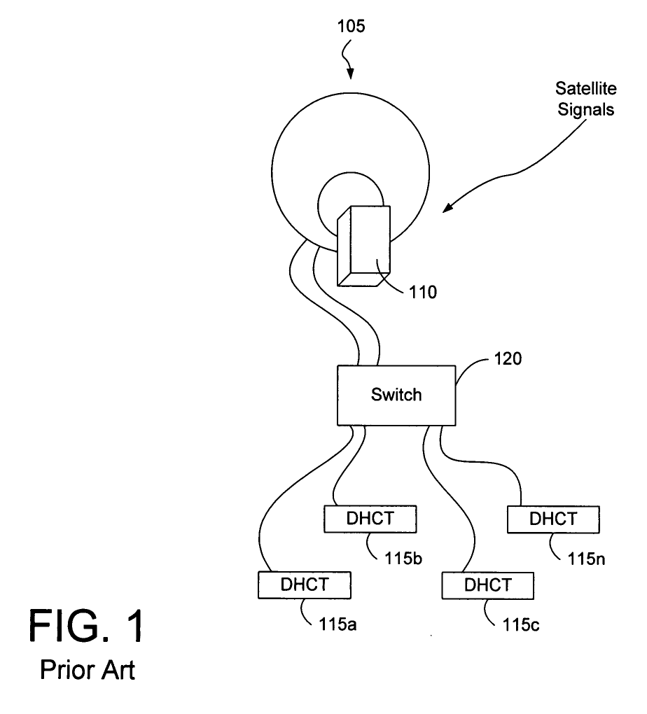

FIG. 1 is a simplified block diagram depicting a non-limiting example of a conventional broadband satellite communications system for one subscriber. Satellite transponders (not shown) in space transmit signals to home satellite receivers 105. A low noise block downconverter (LNB) 110 receives signals from all of the existing transponders and simultaneously mixes and downconverts the signals from, for example, 6 Giga Hertz (GHz) to a range around 1 GHz. The output of the LNB 110 is then a collection of several quaternary phase shift key (QPSK) modulated carriers, a collection for each polarization off of each transponder. Each transponder transmits at a unique combination of frequency and polarization. Also, usually only two polarizations are available. For example, one satellite receiver may receive signals from six transponders (operating at three different frequencies and two polarizations per frequency). In this case, the output of the LNB is three QPSK carriers on one polarization and three more on the other polarization. The receiving devices 115a-n then receive and process the signals via a switch 120 for subsequent display on a television (not shown).

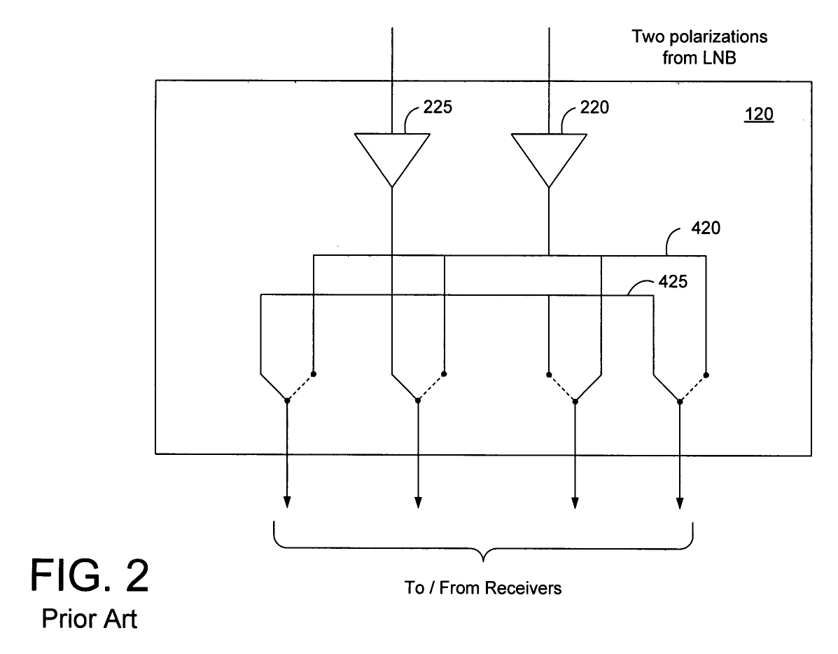

FIG. 2 is a block diagram of the conventional switch 120 that receives signals from the LNB 110 and provides the signals to the plurality of receiving devices 115a-n.

The switch 120 enables the receiving devices 115a-n to select a polarization typically by a receiving device 115 sending a direct current (DC) pulse that causes the switch to choose the polarization. It will be appreciated that other more complex methods exist relating to the switch 120 selecting the frequency and polarization of the desired signals. Amplifiers 220, 225 may be included to amplify the signals, if necessary. Also, the switching function can be performed inside the LNB housing or inside a separate, special-purpose switch box (not shown). If the LNB delivers signals to multiple receiving devices 115, then the switching function is performed, as it is the only way a single LNB can service multiple receiving devices.

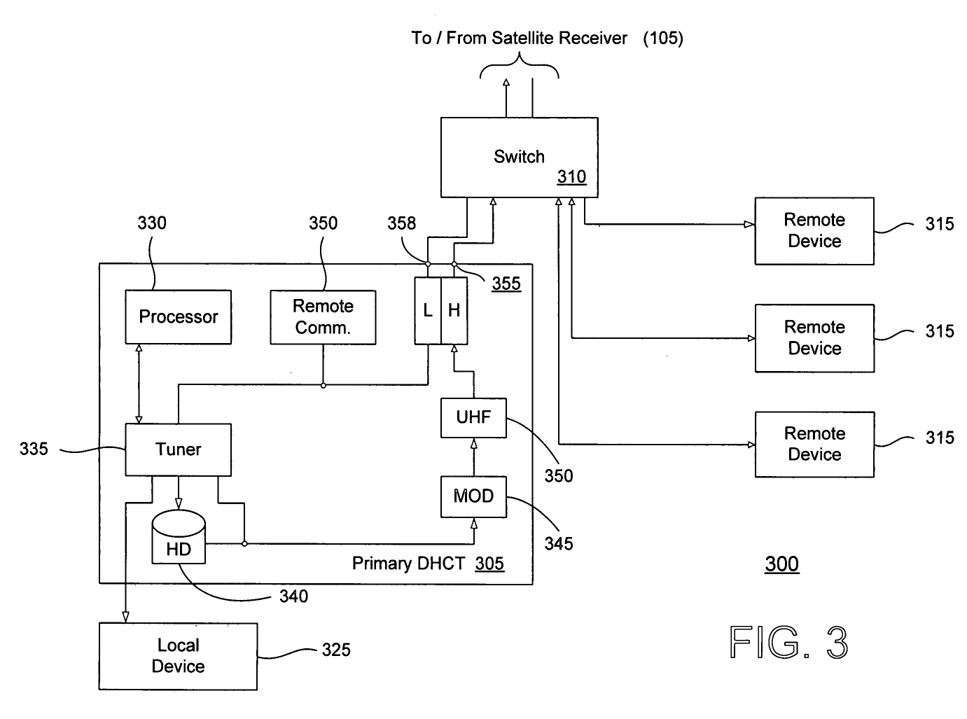

FIG. 3 is a block diagram illustrating one preferred embodiment of a networked multimedia system (NMS) in accordance with the present invention that is suitable for use in the satellite communications system of FIG. 1. The NMS 300 includes a primary DHCT 305, a switch 310, and a plurality of remote devices 315a-n. Briefly, the switch 310 receives downstream broadband signals from the satellite receiver 105 (FIG. 1) and subsequently provides the downstream signals to the primary DHCT 305 or to both the primary DHCT 305 and any one or all of the plurality of remote devices 315a-n depending upon the implementation. Upon command from at least one of the remote devices 315a-n, the primary DHCT 305 may also forward selected real-time downstream signals and/or stored content signals to the requesting remote device(s) 315a-n via the switch 310. More specifically, the plurality of remote devices 315a-n communicates with the primary DHCT 305 by sending reverse control/command signals requesting, for example, stored presentations, real-time signals, or an interactive guide. It will be appreciated that other wired mediums, such as telephone lines, data cables, an infrared (IR) blaster, or in-home wireless transmission, may be used so long as the transport format accommodates the desired transmission medium and that the primary DHCT 305 is programmed to receive that particular transmission scheme. Advantageously, in accordance with the present invention, the plurality of remote devices 315a-n has access to all of the primary DHCT's hardware and software functionality, along with receiving downstream signals directly from the satellite transponders via the switch 310. In this manner, the remote devices 315a-n may have limited resources, such as not including a storage device or a connected record/playback device (not shown), thereby decreasing the overall costs to the service provider and the subscriber while offering advanced services to all of the remote devices 315a-n that are networked to the primary DHCT 305.

FIG. 3 also illustrates a simplified, non-limiting block diagram of selected components of the primary DHCT 305 in accordance with one preferred embodiment of the present invention. In other embodiments, a primary DHCT 305 may include only some of the components shown in FIG. 3, in addition to other components that are not shown. Importantly, however, the primary DHCT 305 includes a processor 330, a tuner system 335, a storage device 340, a modulator 345, and a remote communications device 350. In operation, signals received at the satellite receiver 105 are processed and transmitted via the LNB 110 (FIG. 1). The switch 310, depending upon frequency and polarization, provides the downstream signals to the tuner system 335 in the primary DHCT 305. A plurality of tuners (not shown) included in the tuner system 335 are used to tune to frequency ranges and a polarization that include content signals indicative of presentations, such as an analog or digital television channel, a PPV event, a VOD presentation, etc. Depending upon the implementation, the tuned presentation is then provided to a viewing display 325 for viewing, the storage device 340 for storing, and/or the modulator 345 for modulating and subsequent transmission to the plurality of remote devices 315a-n. Additionally, the user may wish to record the presentation using a peripheral device (not shown), such as a VCR.

In the event that a remote device 315a-n, upon user input, desires a presentation from the primary DHCT 305, a command signal is transmitted from the remote device 315a-n to the switch 310 directing the switch 310 to route the primary DHCT output port 355 to the requesting remote device 315. The remote device 315 then uses the connection to send a request to the remote communications device 350 in the primary DHCT 305. The remote communications device 350 receives and demodulates the command signal according to its transmission method, such as wired or wireless frequency-shift keying (FSK), on-off keying (OOK) transmission, or infrared depending upon the implementation. The processor 330 subsequently receives the demodulated command signal indicative of the requested action (e.g., requesting a stored presentation) and in accordance therewith that instructs the processor to perform the action (e.g., retrieve a stored presentation from the storage device 340).

The presentation's content signals are then provided to the modulator 345, which modulates the selected presentation prior to forwarding to the switch 310, via the tuner 335. A preferred embodiment of the present invention uses a QPSK modulator that performs either DSS or DVB coding, which may be used for effectively transmitting signals in a satellite environment. The modulator 345 presents the modulated signals as if it is a third polarization coming from the satellite (i.e., a different polarization than the two polarizations provided by the satellite receiver 105). In one preferred embodiment of the present invention, prior to delivery to the switch 310, the upconverter 350 converts the frequency of the modulated signals to a predetermined frequency in which the remote devices 315a-n can accept, for example, 1 GHz. The modulated signals are then provided to the switch 310 via output port 355 and a separate coaxial cable. Accordingly, the modulated signals do not interfere with the downstream signals. Alternatively, in another preferred embodiment, the predetermined frequency can be set to an unused frequency in the service provider's frequency map in order to ensure that the networked signals do not conflict with the downstream signals provided by the satellite transponder, or it can be at the same frequency if treated as a different polarization. The primary DHCT 305 could be notified by the satellite transponders indicating which frequencies are unused and, via a software programmable frequency-agile QPSK modulator 345, retune to an unused frequency. Accordingly, the modulated signals from the primary DHCT 305 can be transmitted over the same coaxial cable via output port 358 to the switch 310 for delivery to the remote device 315a-n.

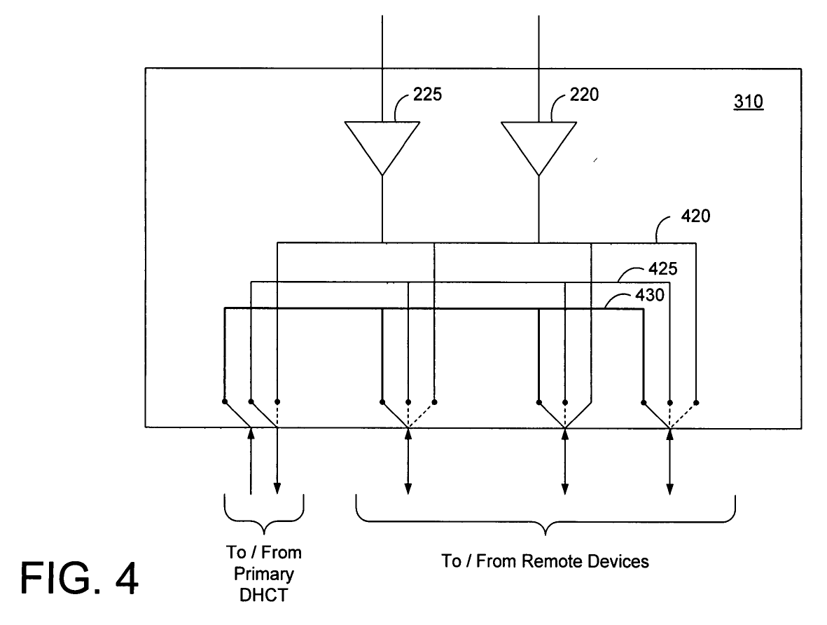

FIG. 4 is an illustration of a switch 310 in accordance with the present invention that is suitable for use in the NMS of FIG. 3. It will be appreciated that the modulated signals provided by the primary DHCT 305 cannot interfere with the downstream path signals. As mentioned, the switch 310 receives the modulated signals from the primary DHCT output port 355 having any frequency and polarization. Since a separate coaxial cable is used, there is no regard given to the downstream signals from the satellite receiver 105. In an alternate embodiment, the switch 310 receives modulated signals from the output port 358 over a common, single coaxial cable between the switch 310 and the primary DHCT 305. The primary DHCT 305 is notified ahead of time, via the downstream signals, which frequencies are not used by the satellite, and it sets its up-converter to use one of the unused frequencies. Hence, the switch 310 can mix the primary DHCT 305 output with the downstream signals received from the satellite with no risk of interference.

The modulated signals (e.g., a stored presentation) are then provided to each of the remote devices 315a-n via the switch 310. Depending upon which remote device 315a-n desires the transmitted signals, that remote device 315 tunes to the particular frequency and polarization known to the network and subsequently receives the networked signals.

Accordingly, systems and methods have been provided that allow a networked multimedia system in a customer's premises that receives signals via a satellite receiver. It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the preferred embodiments of the invention in logic embodied in hardware and/or software-configured mediums.

What is claimed is:

1. A local network system, comprising:
a satellite receiving device for receiving satellite signals from at least one transponder;
a primary DHCT for receiving the satellite signals from the satellite receiving device, and for selectively storing presentations included in the satellite signals, the primary DHCT comprising:
a storage device for storing the at least one presentation;
a modulator for modulating the at least one stored presentation to a predetermined frequency, and for providing the modulated signals; and
a plurality of remote devices coupled to the primary DHCT, each remote device for receiving the satellite signals and for receiving the modulated signals from the primary DHCT.

2. The local network system of claim 1, wherein the modulator is a QPSK modulator.

3. The local network system of claim 1, further comprising a switch for receiving the satellite signals from the satellite receiving device having a first and a second polarization, and for providing the modulated signals having a third polarization.

4. The local network system of claim 3, wherein the modulator assigns the third polarization to the at least one stored presentation.

5. The local network system of claim 3, further comprising a switch for receiving the satellite signals from the satellite receiving device, the satellite signals having a polarization, and for providing the satellite signals to at least one of the primary DHCT and the plurality of remote devices, and for receiving the modulated signals from the primary DHCT and for providing the modulated signals to the plurality of remote devices.

6. The local network system of claim 5, wherein the modulated signals have a polarization that is different than the polarization of the satellite signals.

7. The local network system of claim 1, wherein the satellite signals are transmitted in a plurality of downstream frequency ranges, and wherein the modulated signals are transmitted in the predetermined frequency that is excluded from the plurality of downstream frequency ranges.

8. The local network system of claim 1, further comprising a switch for receiving the satellite signals and the modulated signals, wherein the satellite signals are transmitted in a plurality of downstream frequency ranges, and wherein the modulated signals are transmitted in the predetermined frequency that is included in the plurality of downstream frequency ranges, wherein one of the satellite signals and the modulated signals are selected by a switching function.

9. The local network system of claim 8, wherein the switching function resides in a separate external unit.

10. The local network system of claim 9, wherein the external unit is incorporated in an LNB.

11. The local network system of claim 5, wherein the switching function resides in the primary DHCT.

12. The local network system of claim 1, wherein the plurality of remote devices communicates with the primary DHCT by transmitting at least one reverse command signal.

13. A satellite communications system for transmitting downstream satellite signals from a satellite transponder to a plurality of satellite receivers, the satellite signals transmitted in a plurality of frequencies having a polarization, the satellite receiver network comprising:
a satellite receiver for receiving and processing the downstream satellite signals;
a switch for receiving the processed satellite signals and for providing the processed satellite signals according to a frequency and a polarization;
a primary DHCT coupled to the switch for receiving the processed satellite signals, and for storing and subsequently transmitting desired satellite signals; and
at least one remote device coupled to the switch, the at least one remote device in communication with the primary DHCT, the at least one remote device for receiving the processed satellite signals, and for receiving the stored desired satellite signals from the primary DHCT via the switch.

14. The satellite communications system of claim 13, the primary DHCT comprising a modulator for modulating the stored satellite signals to a predetermined frequency having a polarization prior to transmission to the at least one remote device.

15. The satellite communications system of claim 14, wherein the predetermined frequency having a polarization is excluded from the plurality of frequencies having a polarization of the downstream satellite signals.
